(19) United States
(12) Patent Application Publication
(10) Pub. No.: US 2016/0167254 A1
(43) Pub. Date: Jun. 16, 2016

(54) Apparatus and Method for Creating Additive Manufacturing Filament from Recycled Materials

(71) Applicant: Tethers Unlimited, Inc., Bothell, WA (US)

(72) Inventors: Jesse Cushing, Bothell, WA (US); Jeff Slostad, Bothell, WA (US); Robert Hoyt, Bothell, WA (US); Kristen Turner, Bothell, WA (US)

(21) Appl. No.: 14/971,240

(22) Filed: Dec. 16, 2015

Related U.S. Application Data
(60) Provisional application No. 62/092,515, filed on Dec. 16, 2014.

(51) Int. Cl. B29B 17/00; B29C 47/08; B29B 13/02; B29C 47/34; B29C 47/92; B29C 47/00; B29C 47/86

(52) U.S. Cl. CPC B29B 17/0026; B29C 47/0014; B29C 47/008; B29C 47/0808; B29C 47/862; B29C 47/864; B29C 47/0898; B29C 47/34; B29C 47/92; B29B 13/022; B29C 2947/92704; B29C 2947/9258; B29C 2947/92904; B29C 2947/92514; B29C 2947/92838

(57) ABSTRACT

An additive manufacturing filament production apparatus, having a processing chamber; and a continuous molding module wherein said processing chamber comprises a sealable air-tight housing, a heating element, an actuator-controlled piston, and a vacuum supply.

### CROSS-REFERENCE TO RELATED APPLICATIONS

The present application claims the benefit of provisional application No. 62/092,515, filed Dec. 16, 2014, which is incorporated herein by reference.

### FIELD OF THE INVENTION

The present invention generally relates to recycling materials, and in particular, an apparatus and method for recycling materials to create additive manufacturing filament.

### BACKGROUND INFORMATION

Additive manufacturing processes allow for much less waste of material resources than the subtractive manufacturing processes of the past. Because subtractive manufacturing removes undesired materials to achieve a desired form, much scrap or waste material results. In contrast, additive manufacturing technologies build resource-efficient products by disposing materials layer-by-layer until the desired form is completed. For instance, subtractive manufacturing may waste as much as 95% of the raw materials used to created the final product whereas, if an approximate shape is initially created and then the surfaces are then refined until smooth, additive manufacturing may waste a mere 5%.¹ ¹ http://www.economist.com/blogs/babbage/2013/12/advanced-manufacturing

While additive manufacturing is less wasteful, it remains a consumption-based technology using raw materials to create a product. An estimated 30 million pounds of plastic is used in additive manufacturing processes each year and much of that is from non-recycled or virgin plastic. It is estimated that by 2020, approximately 250 million pounds of plastic will be used in additive manufacturing.² Furthermore, in addition to plastic, additive manufacturing filament may be comprised of glass, metal, ceramic, or composite materials. Therefore, as additive manufacturing continues to develop as a viable manufacturing technology, the usage of raw material will grow thereby furthering the paradigm of consumption. Continued use of raw ² http://www.rapidreadytech.com/2015/02/3d-filament-from-recycled-plastics/material is therefore not a best practice for a green technology. Rather it is preferred to recycle and reuse existing or waste products.

Many recycling centers in the United States have a backlog of items that need to undergo the recycling process. Rather than sending recyclable goods to a centralized location, it is preferred that individuals may have a personal mechanism for recycling materials that may be reused. Additionally, there are environments where sending raw materials for use in additive manufacturing is prohibitively expensive and there is already waste that may be recycled into additive manufacturing filament such as space. It is preferred that anything sent into space be used, recycled, and reused because of the cost to not only send it up to space but also to get it back to Earth.

In order to reduce the consumption of virgin materials and further the evolution of additive manufacturing as a sustainable technology, it is useful to create filament by recycling post-consumer goods. Prior art attempts to create additive manufacturing filament from recycled materials generally consist of a hopper to filter the materials into the device, a shredding mechanism to cut the material into smaller pieces or pellets so that it may fit into the additive manufacturing machine and melts faster, a heating mechanism to melt the material, an auger to push the molten material through a nozzle, and a spooling assembly. They do not resolve the key issues of creating filament that has consistent diameter throughout, can be paused and restarted without affecting the quality of the filament created, and that is unaffected by moisture content with minimized polymer degradation. Conventional filament manufacturing machines use heated forced air to dry the material prior to melting and pulling the molten material by a speed controlled pulling machine to draw it down to a desired thickness. These prior art designs rely on high viscosity and internal stress uniformity for the material to hold its desired shape, cooling while physically unconstrained.

Therefore, what is needed is an apparatus and method, which creates filament with uniform cross-sectional size and compositional consistency for additive manufacturing machines from recycled materials. Additional benefits from such an invention include reduced costs to users of additive manufacturing devices due to high use of filament and reduction of costs as well as impact on the environment due to costs and carbon emissions associated with recyclable goods transportation to a centralized recycling site.

### SUMMARY OF THE INVENTION

In general, in one aspect, the invention relates to a recycler apparatus for processing virgin or scrap materials with arbitrary geometries directly into monofilament feed stock for an additive manufacturing device. In general, in an alternate aspect, the invention relates to an apparatus for efficiently producing small batches of custom compounded material formulations of additive manufacturing device filament, including the production of alloys of multiple resins, and mixing-in of particulate fillers, fiber fillers, or nanoparticle fillers. In general, in a further alternate aspect, the invention relates to a recycling apparatus for drying, degassing, melting, consolidating, and pumping melt-processable materials. In general, in one aspect, the invention relates to an additive manufacturing device feedhead apparatus, which takes scraps of material with arbitrary geometries, creates filament, and directly feeds the filament into the additive manufacturing device. In general, in one aspect, the invention relates to a method of continuous molding in which a stream of molten material is solidified within an actively cooled solid die with a non-stick surface.

### BRIEF DESCRIPTION OF THE DRAWINGS

These and other features and advantages of the present invention will be better understood by reading the following Detailed Description, taken together with the Drawings wherein:

FIG. 1 is a laterally elevated view of one embodiment of the present invention;

FIG. 2 is a lateral partial view of a processing chamber in accordance with one or more embodiments of the invention.

FIG. 3 is a lateral partial view of a continuous molding module in accordance with one or more embodiments of the present invention.

FIG. 4 is a detailed lateral view of a temperature-controlled nozzle in accordance with one or more embodiments of the present invention.

FIG. 5 shows a flowchart in accordance with one or more embodiments of the present invention.

### DETAILED DESCRIPTION OF THE PREFERRED EMBODIMENTS

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide an apparatus and method to recycle arbitrary geometries of material and use them to create filament for an additive manufacturing device. A processing chamber is configured to reprocess arbitrary geometries of material into a stream of molten material. A continuous molding module is configured to convert the stream of molten material into solidified product with highly controlled and comprehensively consistent geometry by solidifying the material while moving through a series of cooled rigid molds, with no structural reinforcements that remain solid in the melt to allow pulling of the material through the cooled mold. An automatic spooling mechanism winds the filament.

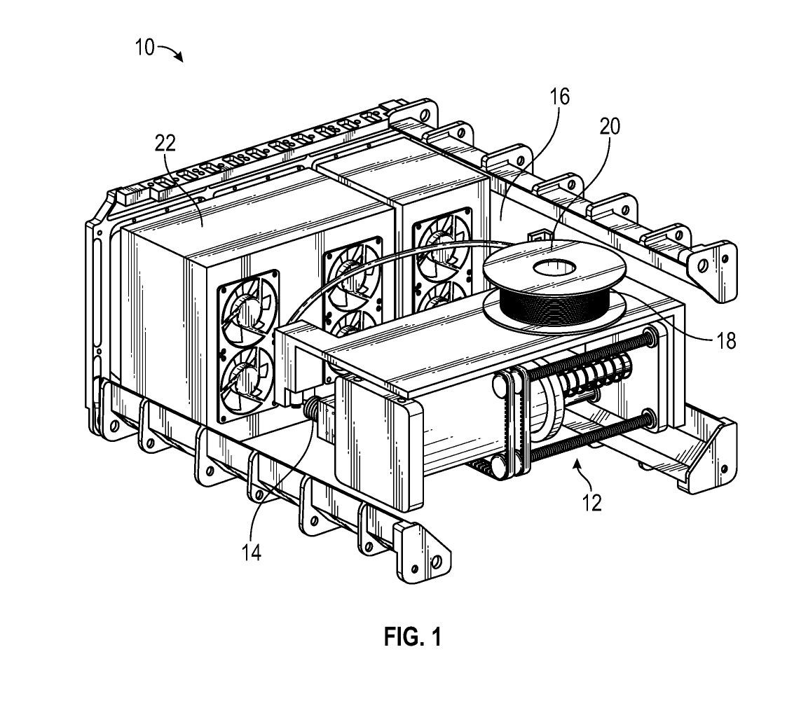

The embodiment of FIG. 1 provides an apparatus for creating additive manufacturing filament in accordance with one embodiment of the present invention, generally designated by reference numeral 10. A processing chamber 12 is connectively attached to a continuous molding module 14. The processing chamber 12 is configured to reprocess arbitrary geometries of materials into a stream of molten material. In one embodiment of the invention, the processing chamber 12 is used directly as the feedhead of an additive manufacturing device. In an embodiment of the invention, a mixing module is disposed between the processing chamber 12 and the continuous molding module 14 for producing filament comprising a particle-filled composite compound. In an embodiment of the invention, a continuous fiber deposition module is disposed between the processing chamber 12 and the continuous molding module 14. The continuous molding module is configured to form and solidify the molten material into filament. An automatic spooling mechanism 16 is configured to receive the filament 18, winding it onto a spool 20 and an atmosphere control unit 22 is configured to capture and eliminate outgassing and particulate products generated by the apparatus 10. In an embodiment of the invention the atmosphere control unit comprises a plurality of HEPA filters, activated carbon filters, cold plate condensers, and an exhaust ventilation. In an embodiment of the invention a motion and temperature control module is configured to monitor and manage the processing chamber and continuous molding module.

In an embodiment of the invention the filament feeds directly into an additive manufacturing device. In a further embodiment of the invention the apparatus is connectively attached to the feedhead of an additive manufacturing device. In an embodiment of the invention, a control unit monitors and controls the motion of the molten material and filament through the relevant parts of the apparatus 10 as well as controlling the temperatures of each part of the apparatus 10.

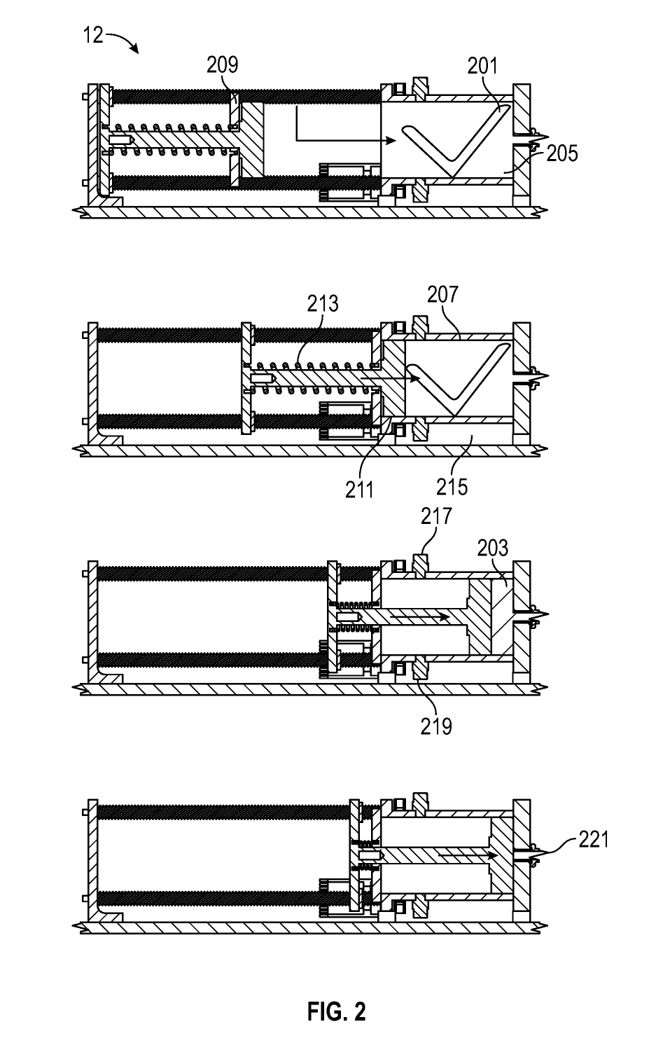

FIG. 2 provides a detailed view of the processing chamber 12 in various stages. The processing chamber 12 is configured to receive any input 201 of arbitrary geometry that may be converted into filament for an additive manufacturing device. This includes objects made from any virgin or pre-processed polymers, copolymers, polymer precursors, metals, or composite materials. Upon exiting the processing chamber 12, the input 201 is converted into molten material 203. In an embodiment of the invention, the processing chamber 12 provides an airtight housing 205. In FIG. 2, the housing has a cylindrical shape to ensure that all of the molten material exits the housing however, one skilled in the art can appreciate that any geometric shape for the housing may be used. In an alternate embodiment of the invention the processing chamber 12 provides multiple housings. In an embodiment of the invention, the inner surface 207 of the housing 205 is non-stick.

A door 209 on one side of the housing 205 opens to receive the input 201 and closes to form an airtight seal. On the side of the door facing the interior of the housing 205, the head 211 of a pivoting screw driven piston 213 is configured to compact and consolidate molten material 203. In an embodiment of the invention the pivoting screw driven piston 213 is configured to advance with a high force pumping the molten material 203 into the continuous molding module 14. In an embodiment of the invention the screw driven piston 213 is actuated by a single screw jack. In an alternate embodiment of the invention the screw driven piston 213 is actuated by multiple lead screws. In a further alternate embodiment of the invention, the screw driven piston 213 is actuated by telescoping lead screws. In another alternate embodiment of the invention, the screw driven piston 213 is actuated by telescoping hydraulic actuators. In yet a further alternate embodiment of the invention, the screw driven piston 213 is actuated by telescoping pneumatic actuators.

Adjacent to the housing 205 is a heating element 215. The heating element 215 is configured to vaporize moisture and any volatile contaminates. The heating element 215 is further configured to raise the temperature of the housing to a material processing temperature. In an embodiment of the invention a vacuum supply 217 and an inert gas supply 219 are connectively attached to the housing 205. The inert gas supply 219 is configured to relieve the vacuum limiting any undesired outgassing while preventing oxidation of the molten material 203. A nozzle 221 is disposed on at least one side of the housing 205. The nozzle 221 is configured to allow the molten material 203 to exit from the processing chamber 12. In an embodiment of the invention the nozzle 221 feeds into a positive displacement pump configured to augment the pressure of the molten material 203 in order to force the molten material through the continuous molding module and allow for flow metering. In an embodiment of the invention, the positive displacement pump is further configured to precisely control the molten material feed rate. In an embodiment of the invention, the positive displacement pump is a gear pump. In a further embodiment of the invention the nozzle 221 feeds into the continuous molding module 14.

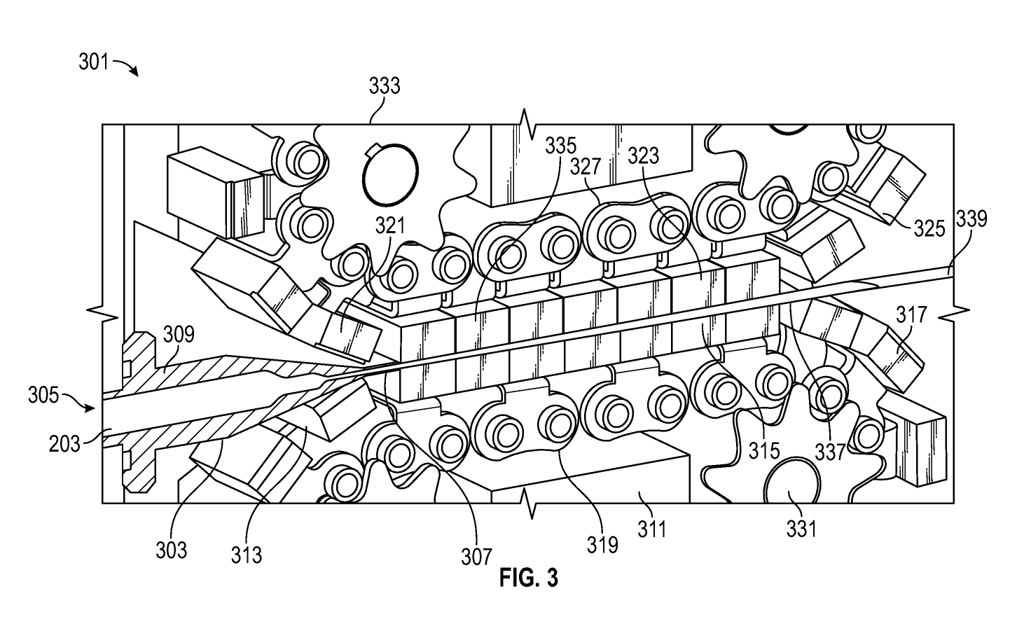

FIG. 3 is a lateral partial view of a continuous molding module in accordance with one or more embodiments of the present invention. A static cooling die 301 comprises a temperature-controlled nozzle 303. In an embodiment of the invention, the temperature-controlled nozzle is stationary. On an input side of the temperature-controlled nozzle 303, an inlet 305 is configured to have an inlet temperature. On an output side of the temperature-controlled nozzle 303, an outlet 307 is configured to have an outlet temperature. The inlet temperature is configured to be above a processing temperature of the molten material 203 and the outlet temperature is further configured to be below a softening temperature of the molten material 203. A temperature control module 309 is disposed adjacent to the temperature-controlled nozzle 303. In an embodiment of the invention the temperature-controlled nozzle 303 has a non-stick internal surface. The inner surface of the temperature-controlled nozzle 303 may be lined or may comprise any commercially available non-stick, low-friction material such as Teflon. In an embodiment of the invention, the temperature-controlled nozzle 303 cools the molten material while molding it to a desired diameter so that it may be immediately spooled. In an alternate embodiment of the invention, the outlet 307 feeds into a recirculating molding module 311.

The recirculating molding module 311 is configured to mold the molten material into a desired geometry that is comprehensively consistent. A plurality of lower mold plates 313, 315, and 317 are linked to a lower track 319 in a series. A plurality of upper mold plates 321, 323, and 325 are linked to an upper track 327 in a series. The lower and upper tracks, 319 and 327 respectively, are guided by a lower and an upper recirculating mechanism 331 and 333, respectively.

The lower and upper tracks, 319 and 327 respectively, are configured to join the plurality of lower mold plates 313, 315, and 317 and plurality of upper mold plates 321, 323, and 325 to create a nearly closed mold 335 which traverses along a molding path 337. The nearly closed mold 335 encloses the molten material 203, which is cooled as the nearly closed mold 335 traverses a span of the molding path 337. At the end of the molding path 337, the molten material 203 is molded into filament 339 and the nearly closed mold 335 separates allowing the plurality of lower mold plates 313, 315, and 317 and plurality of upper mold plates 321, 323, and 325 to continue along the lower track and upper track, 319 and 327, respectively.

In an alternate embodiment of the invention, the plurality of upper mold plates and plurality of lower mold plates are linked to an upper circulating chain and a lower circulating chain, respectively. In a further alternate embodiment of the invention, a recirculating upper flexible belt and a recirculating lower flexible belt join to form a mold cavity. In a yet further embodiment of the invention, the plurality of upper mold plates and plurality of lower mold plates are reciprocating, sliding along a molding path and opening slightly to assist as needed in releasing any adhesions of the material to the mold plates. In an embodiment, a tension control mechanism is configured to prevent flowing of the molten material into seams between the individual mold plates when the mold plates separate. The tension control mechanism is further configured to ensure that the molten material is pressed out into contact with the mold interior while the mold is closed. In an embodiment of the invention, the temperatures of the plurality of upper mold plates and plurality of lower mold plates are controlled to allow complete or partial molding of the molten material

In an embodiment of the invention the filament 339 winds onto a spool by an automatic spooling mechanism. The automatic spooling mechanism comprises a set of pinch rollers acting on the filament. The set of pinch rollers are configured to guide the filament 339 through a Bowden tube to a level wind guide. A linear stage is configured to create a neat level wind and allow control over a wind pattern of the filament onto a spool. In an embodiment of the invention the filament passes through a cold working stage configured to bend the filament to achieve a relaxed strain state while in a curved path around the spool, and the amount of curvature induced is matched to the changing radius of curvature of the spool over the course of the wind. In an alternate embodiment of the invention a variable curvature can be imparted before the molten material is completely solidified by actuating the curvature of a flexible non-stick guide tube between the continuous molding module and the pinch rollers.

In an embodiment of the invention, the spool includes a mechanism for automatically initiating winding. In an embodiment of the invention, an axial rotation of the spool is actuated to maintain tension on the filament once winding has been initiated. In an embodiment of the invention a cutting mechanism is configured to automatically cut filament. In an embodiment of the invention a loading mechanism is configured to automatically load an empty spool for winding.

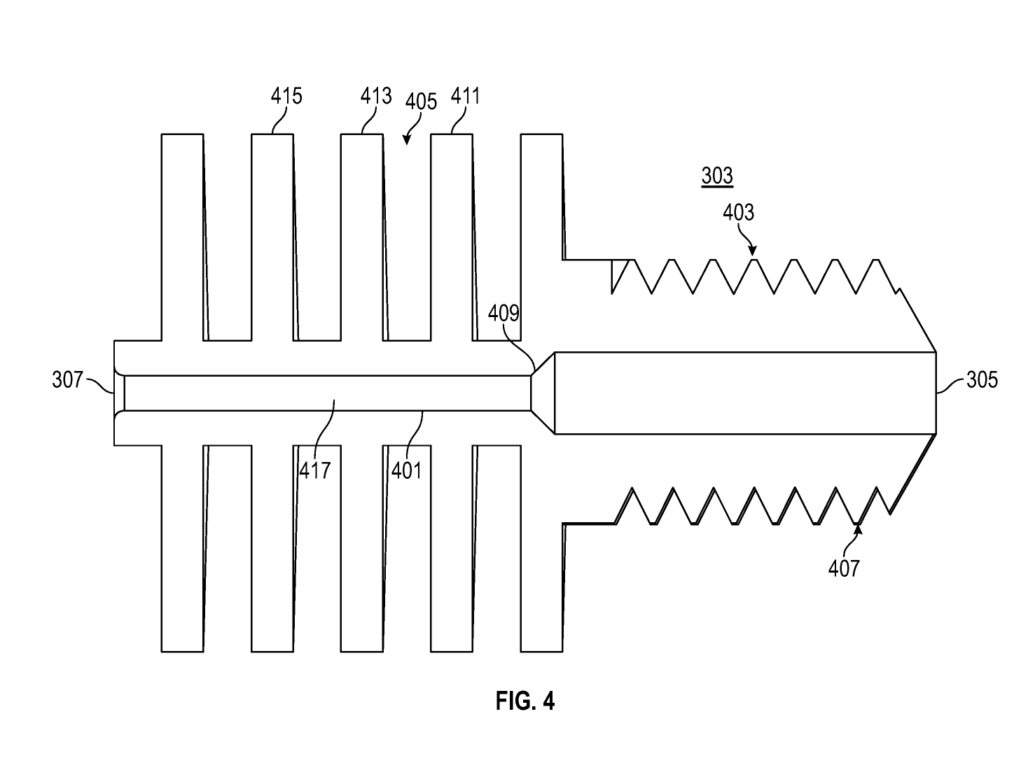

FIG. 4 is a detailed lateral view of a temperature-controlled nozzle 303 in accordance with one or more embodiments of the present invention. In an embodiment of the invention, the temperature-controlled nozzle 303 is stationary. In general, in accordance with an embodiment of the invention, the temperature-controlled nozzle 303 is configured to cool the molten material while molding it to a desired geometry and/or diameter. In general, in accordance with an alternate embodiment of the invention, the temperature-controlled nozzle is configured to initially heat the molten material and then cool the molten material while molding it to a desired geometry and/or diameter.

As described previously, the temperature-controlled nozzle 303 comprises an inlet 305 and an outlet 307. In an embodiment of the invention, the molten material enters the temperature-controlled nozzle 303 at inlet 305 and exits the temperature-controlled nozzle 303 at outlet 307 as filament. An inner surface 401 of the temperature-controlled nozzle 303 is configured to allow low-friction flow of the molten material through the temperature-controlled nozzle 303. In an embodiment of the invention, the inner surface 401 of the temperature-controlled nozzle 303 comprises any material allowing high-lubricity during flow of the molten material through the temperature-controlled nozzle 303 or a non-stick material. In an embodiment of the invention, the inner surface 401 is coated with a non-stick material. Any commercially available non-stick, low-friction material such as Teflon may be used to coat the inner surface 401. The temperature-controlled nozzle 303 comprises two sections; a heated die section 403 and a cooling die section 405. Threading 407 allows the temperature-controlled nozzle 303 to screw into a gear pump and funnel 409 is configured to guide the molten material as it flows into the cooling die section 405. The cooling die section 405 comprises a plurality of fins 411, 413, and 415 configured to actively cool the molten material and an inner molding structure 417 configured to form the molten material into a desired geometric shape and circumference as it cools. In an embodiment of the invention, forced convection across the plurality of fins 411, 413, and 415 is used to cool the molten material though one with ordinary skill in the art will appreciate that any cooling mechanism that will decrease the temperature of the molten material to a solidifying state may be used.

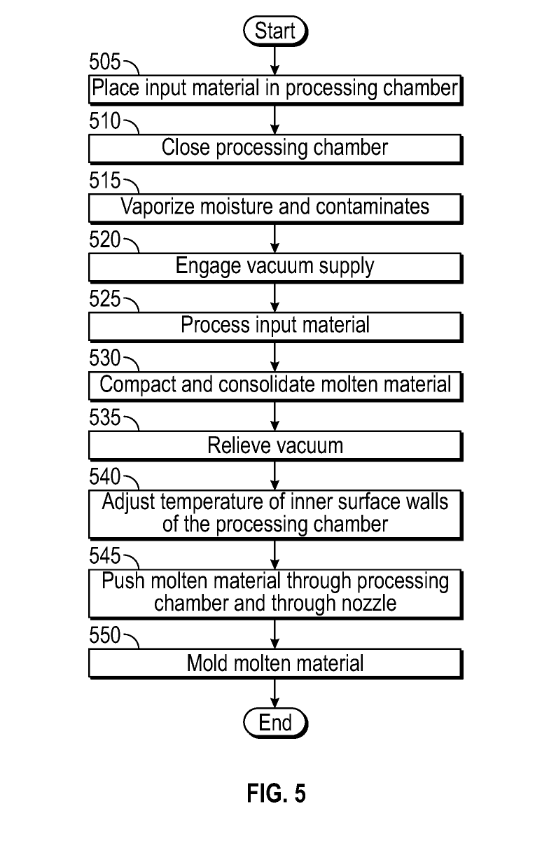

FIG. 5 shows a flowchart in accordance with one or more embodiments of the present invention. Specifically, FIG. 5 shows a flowchart of a method for creating filament for an additive manufacturing device in accordance with one or more embodiments of the invention. In one or more embodiments of the invention, one or more of the steps described with respect to FIG. 5 may not be performed, may be performed in a different order, and/or may be repeated. According, the specific arrangement of steps shown in FIG. 5 should not be construed as limiting the scope of the invention in any way.

In one or more embodiments of the invention, in step 505, a user opens the processing chamber to place input material inside. Specifically, a user opens a door to access the processing chamber and places the input material inside the processing chamber. In step 510, the user closes the processing chamber creating an airtight seal around the processing chamber. In step 515, the processing chamber activates a heating element. The heating element applies heat to the processing chamber causing the input material to vaporize moisture and other volatile contaminates. In step 520, a vacuum supply is engaged to evacuate air within the processing chamber and any gaseous volatiles. In step 525, the heating element applies additional heat to the processing chamber causing the temperature of the input material to increase to a processing temperature. The input material is melted to become molten material. In step 530, a piston disposed on one side of the processing chamber traverses a first length of the processing chamber compacting and consolidating the molten material. In step 535, an inert gas supply is activated to relieve the vacuum. The inert gas may be any available inert gas that is configured to limit any undesired outgassing and prevent oxidation of the molten material. In an embodiment of the invention, an inert gas supply activation may occur at the same time as step 520. A temperature control mechanism is configured to adjust the temperature of the processing chamber. In step 540, the temperature control mechanism adjusts the temperature around inner surface walls of the processing chamber to solidify the molten material at the edges of the piston preventing leaking of the molten material past the piston. In step 545, the piston traverses a second length of the processing chamber with a high force pushing the molten material through a cooling nozzle. In step 550, a continuous molding module molds the molten material into additive manufacturing device filament. In an embodiment of the invention, steps 545 and 550 may be combined such that the cooling nozzle is configured to cool the molten material and mold the molten material into a filament with a desired geometry and diameter for an additive manufacturing device.

While the principles of the invention have been described herein, it is to be understood by those skilled in the art that this description is made only by way of example and not as a limitation as to the scope of the invention. Further embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. An additive manufacturing filament production apparatus, comprising:
a processing chamber; and
a continuous molding module
wherein said processing chamber comprises a sealable air-tight housing, a heating element, an actuator-controlled piston, and a vacuum supply.

2. The additive manufacturing filament production apparatus of claim 1, wherein said continuous molding module comprises a static molding nozzle.

3. The additive manufacturing filament production apparatus of claim 2, wherein said static molding nozzle comprises a heated module and a cooling die module.

4. The additive manufacturing filament production apparatus of claim 1, wherein said continuous molding module comprises a nozzle; a circulating chain of lower molding plates connectively attached to a lower rotation module; and a circulating chain of upper molding plates connectively attached to an upper rotation module.

5. The additive manufacturing filament production apparatus of claim 1, wherein said continuous molding module comprises a nozzle; a circulating lower molding belt; a lower rotating mechanism; a circulating upper molding belt; and an upper rotating mechanism.

6. The additive manufacturing filament production apparatus of claim 1, wherein said continuous molding module comprises a sliding nozzle; at least one lower reciprocating mold plate; at least one upper reciprocating mold plate; and a tension control mechanism.

7. The additive manufacturing filament production apparatus of claim 2 further comprising an automatic spooling module.

8. The additive manufacturing filament production apparatus of claim 5, wherein said automatic spooling mechanism comprises a plurality of pinch rollers; a guiding tube; a level wind guide; a linear stage; and a working stage.

9. The additive manufacturing filament production apparatus of claim 1 further comprising an atmosphere control unit.

10. The additive manufacturing filament production apparatus of claim 1 further comprising a motion and temperature control module.

11. The additive manufacturing filament production apparatus of claim 1, wherein said processing chamber further comprises an inert gas supply.

12. The additive manufacturing filament production apparatus of claim 1, wherein said sealable airtight housing comprises a non-stick inner surface.

13. The additive manufacturing filament production apparatus of claim 2, wherein said static cooling nozzle comprises a non-stick inner surface.

14. The additive manufacturing filament production apparatus of claim 1, wherein said processing chamber further comprises a gear pump.

15. A method for producing additive manufacturing filament, comprising:
placing at least one input material inside a processing chamber;
sealing said processing chamber;
applying a first heating process to said processing chamber;
engaging a vacuum supply to said processing chamber;
applying a second heating process to said processing chamber;
actuating a piston to traverse a first length of said processing chamber;
activating a temperature control module; and
actuating said piston to traverse a second length of said processing chamber,
wherein said second heating process increases an inner chamber temperature of said processing chamber to a processing temperature of said at least one input material.

16. The method of producing additive manufacturing filament of claim 15, further comprising engaging an inert gas supply to said processing chamber.

17. The method of producing additive manufacturing filament of claim 15, further comprising injecting a processed input material through a static molding nozzle wherein said static molding module heats said processed input material in a heating section and molds said processed material in a cooling section.

18. The method of producing additive manufacturing filament of claim 17, wherein said at least one of a plurality of recirculating molding mechanisms comprises:
joining of an upper mold plate linked to an upper recirculating track to a lower mold plate linked to a lower recirculating track;
receiving said processed input material on at least one of a plurality of recirculating molding mechanisms;
traversing a molding path;
separating of said upper mold plate linked to said upper recirculating track and said lower mold plate lined to said lower recirculating track; and
releasing a molded processed input material.
